(19) United States
(12) Patent Application Publication
(10) Pub. No.: US 2013/0151016 A1
(43) Pub. Date: Jun. 13, 2013

(54) HEATING, VENTILATION AND AIR CONDITIONING SYSTEM USER INTERFACE HAVING A ONE-TOUCH AWAY FEATURE AND METHOD OF OPERATION THEREOF

(71) Applicants: Larry S. Bias, Prosper, TX (US); Daniel Castillo, Plano, TX (US); Bobby DiFulgentiz, Frisco, TX (US); Gabaza B. Mlambo, McKinney, TX (US); Stephen J. Vendt, Little Elm, TX (US)

(72) Inventors: Larry S. Bias, Prosper, TX (US); Daniel Castillo, Plano, TX (US); Bobby DiFulgentiz, Frisco, TX (US); Gabaza B. Mlambo, McKinney, TX (US); Stephen J. Vendt, Little Elm, TX (US)

(73) Assignee: Lennox Industries Inc., Richardson, TX (US)

(21) Appl. No.: 13/432,524

(22) Filed: Mar. 28, 2012

Related U.S. Application Data
(60) Provisional application No. 61/569,859, filed on Dec. 13, 2011.

(51) Int. Cl. G05D 23/19; G06F 3/041

(52) U.S. Cl. 700/276; 345/173

(57) ABSTRACT

A user interface for use with an HVAC system, a method of controlling an HVAC system and an HVAC system incorporating the user interface or the method. In one embodiment, the user interface includes: (1) a display configured to provide information to a user, (2) a touchpad configured to accept input from the user and (3) a processor and memory coupled to the display and the touchpad and configured to drive the display and process the input, the display further configured to display a most-often displayed screen including a one-touch away button and place the HVAC system into an energy-saving operating mode based on a single press of the one-touch away button.

### CROSS-REFERENCE TO RELATED APPLICATION

This application claims the benefit of U.S. Provisional Application Ser. No. 61/569,859, filed by Bias, et al., on Dec. 13, 2011, entitled “Heating, Ventilation and Air Conditioning System User Interface Having One or More of One-Touch Away Feature, Adjustable Fonts, Proportional Animation Graphics, Service Reminders on a Single Screen, Separate Programming and Manual Mode Screens, Integrated Screen/Housing Skin, Low-Profile Housing, Secure Functional Upgrade Feature and Remote Platform Access Application Associated Therewith,” commonly assigned with this application and incorporated herein by reference.

### TECHNICAL FIELD

This application is directed, in general, to a heating, ventilation and air conditioning (HVAC) systems and, more specifically, to an HVAC system having a user interface, such as a thermostat.

### BACKGROUND

Users interact with HVAC systems through user interfaces. The most common user interface employed today is the thermostat. The most basic thermostats feature one or more dials, switches or levers and allow users to set temperatures. More elaborate thermostats feature a liquid crystal display (LCD) screen, perhaps even of the touchscreen variety, and allow users to program their HVAC systems for automatic temperature settings, configure and maintain their HVAC systems and records of historical operation data, allowing the users to gauge the performance and efficiency of their HVAC systems.

Thermostats necessarily include both temperature sensors and control circuitry within their housings. Some user interfaces do not qualify as thermostats, because while they communicate with temperature sensors and control circuitry, they do not include both within their housings.

### SUMMARY

One aspect provides a user interface for use with an HVAC system. In one embodiment, the user interface includes: (1) a display configured to provide information to a user, (2) a touchpad configured to accept input from the user and (3) a processor and memory coupled to the display and the touchpad and configured to drive the display and process the input, the display further configured to display a most-often displayed screen including a one-touch away button and place the HVAC system into an energy-saving operating mode based on a single press of the one-touch away button.

Another aspect provides a method of controlling an HVAC system. In one embodiment, the method includes: (1) providing information to a user with a display, (2) accepting input from the user with a touchpad, (3) displaying a most-often displayed screen including a one-touch away button on the display and (4) placing the HVAC system into an energy-saving operating mode based on a single press of the one-touch away button.

Yet another aspect provides an HVAC system. In one embodiment, the HVAC system includes: (1) a heat pump or a compressor having at least one stage, (2) at least one condenser coil, (3) an expansion valve, (4) at least one evaporator coil, (5) a loop of pipe interconnecting the heat pump or compressor, the at least one condenser coil, the expansion valve and the at least one evaporator coil and containing a refrigerant, (6) at least one fan configured to cause outdoor air and indoor air to blow over the at least one condenser coil and the least one evaporator coil and (7) a user interface, including: (7a) a display configured to provide information to a user, (7b) a touchpad configured to accept input from the user and (7c) a processor and memory coupled to the display and the touchpad and configured to drive the display and process the input, the display further configured to display a most-often displayed screen including a one-touch away button and place the HVAC system into an energy-saving operating mode based on a single press of the one-touch away button.

### BRIEF DESCRIPTION

Reference is now made to the following descriptions taken in conjunction with the accompanying drawings, in which:

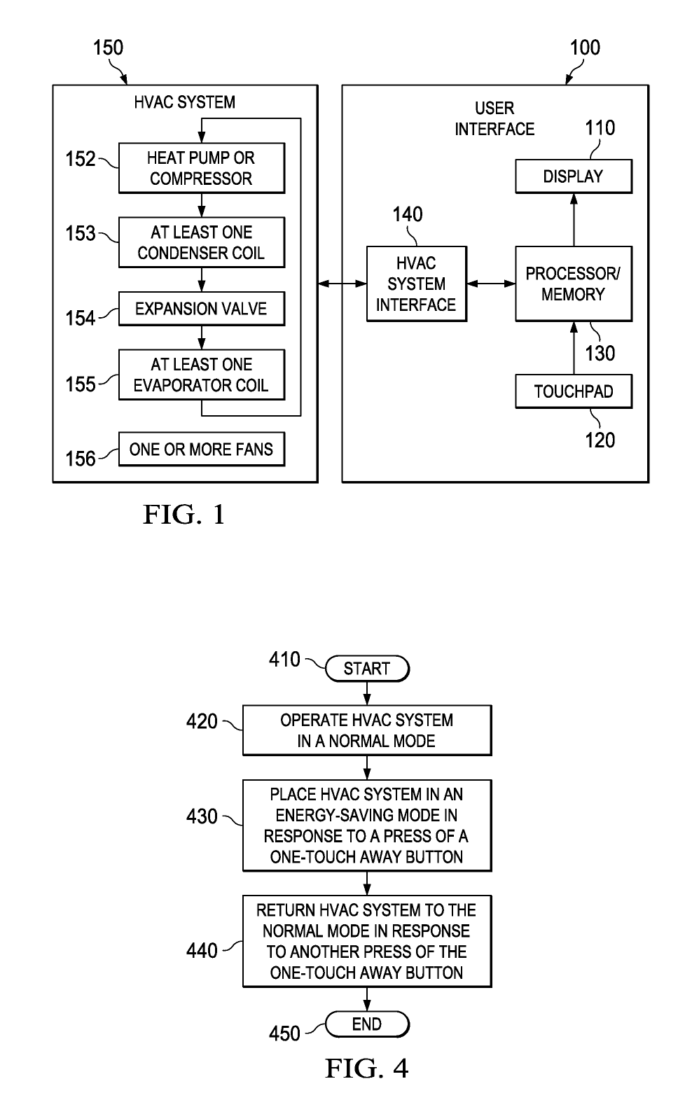

FIG. 1 is a block diagram of one embodiment of a user interface;

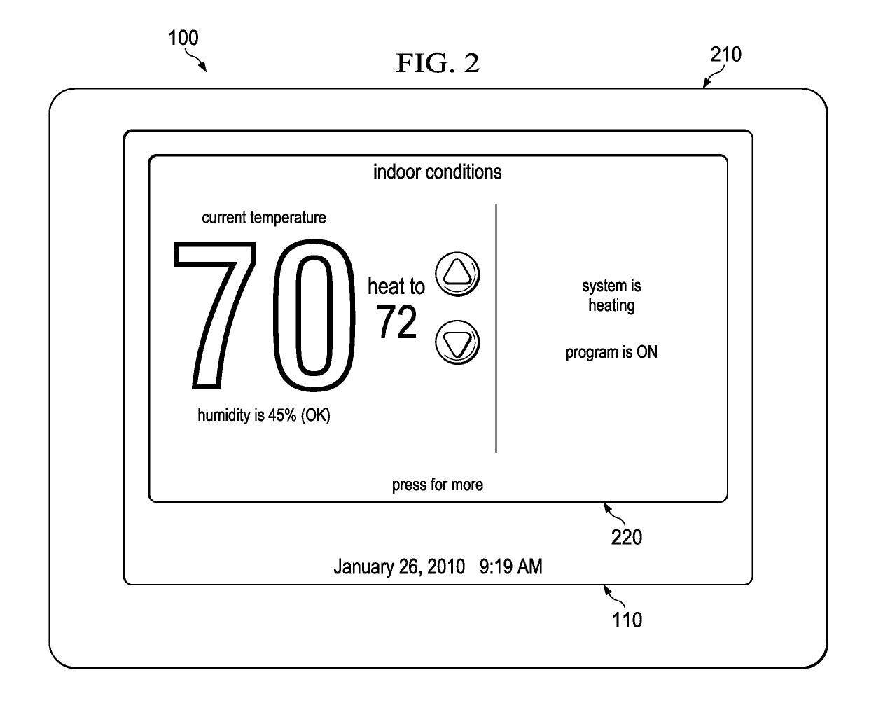

FIG. 2 is a front-side elevational view of one embodiment of a user interface;

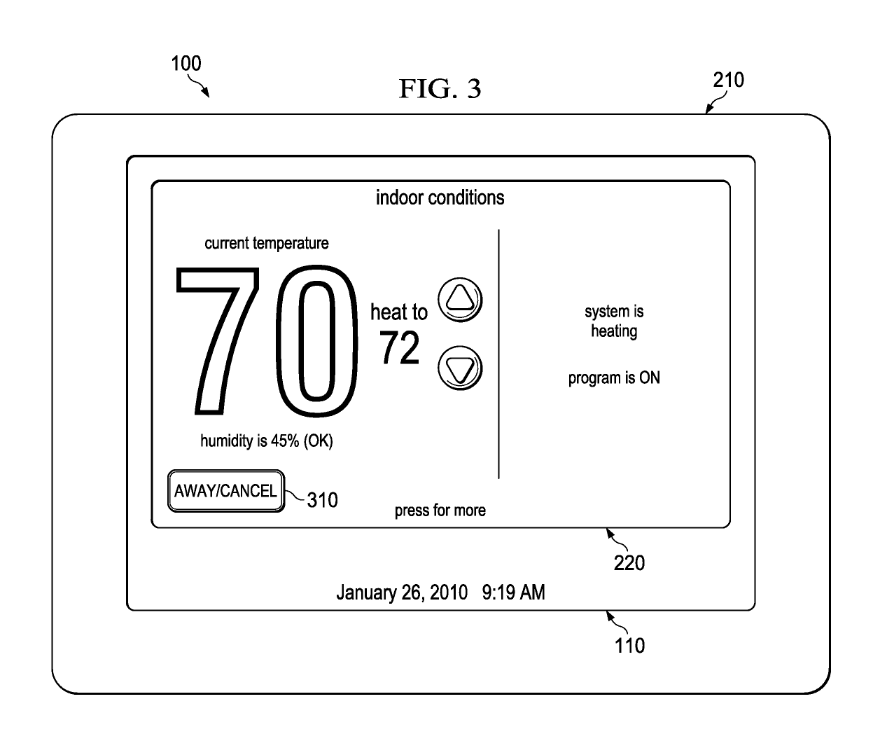

FIG. 3 is a representation of one embodiment of a screen of the user interface of FIG. 2 having one embodiment of a one-touch away feature; and

FIG. 4 is a flow diagram of one embodiment of a method of controlling an HVAC system.

### DETAILED DESCRIPTION

FIG. 1 is a block diagram of one embodiment of a user interface 100. The interface has a display 110 and a touchpad 120. The display 110 is configured to provide information to a user, and the touchpad 120 is configured to accept input from a user. A processor and memory 130 are coupled to the display 110 and the touchpad 120 to drive the display 110 and process the input from the touchpad 120. More accurately, software or firmware is loaded into and stored in the memory and, when executed in the processor, configures the processor to drive the display 110 and process the input from the touchpad 120. An HVAC system interface 140 is coupled to the processor and memory 130 and is configured to provide communication between the processor and memory 130 and the remainder of an HVAC system 150. In various embodiments, the HVAC system 150 includes one or more loops of pipe (one being shown and referenced as 151) containing a refrigerant. Each loop transports the refrigerant among a heat pump or a compressor 152 having at least one stage, at least one condenser coil 153, an expansion valve 154 and at least one evaporator coil 155. One or more fans (“blowers”) 156 cause outdoor air and indoor air to blow over the at least one condenser coil 153 and the at least one evaporator coil 155 to transfer heat to or from them. Those skilled in the pertinent art are familiar with conventional HVAC systems and generally understand the many embodiments and forms they may take.

FIG. 2 is a front-side elevational view of one embodiment of the user interface of FIG. 1. The user interface 100 has a bezel 210. The display 110 is configured to display at least one screen 220 of information for the benefit of a user (the term also including an installer or any other person interested in gaining information from the user interface 100). The screen 220 of FIG. 2 is a most-often displayed screen (defined as a screen that the user interface 100 typically displays or displays more often than any other screen or screens while the HVAC system is in an operating mode (e.g., not being configured by a user).

Although unreferenced, the screen 220 shown in FIG. 2 includes a current temperature display portion, a setpoint temperature display portion, buttons to raise or lower the setpoint temperature, a system mode message display portion (i.e., “system is heating”) and a program status message display portion (i.e., “program is on”). The screen 220 also has current date and time display portions and allows the user to display other screens (via a “press for more” message).

FIG. 3 is a representation of one embodiment of a screen of the user interface of FIG. 2 having one embodiment of a one-touch away feature.

Conventional user interfaces (typically thermostats), require users to press at least multiple buttons to place the system into any type of “away” (energy saving) operating mode. The first button push typically takes the user from a screen that is most often displayed to a screen in which different operating modes may be selected. In some cases, one, two or even more further button pushes are then required to select an “away” or energy-saving operating mode and cause the system to enter it. The same holds true with the user wants to restore normal operation; the user is typically required to navigate to the screen in which different operating modes may be selected and then, by one or more further button pushes, select and engage the normal operating mode. Still further button pushes may be required to return to the screen that is most often displayed (e.g., a “home screen”).

The one-touch away feature described herein simplifies the process by making the transition from occupied to away (and vice versa) a single button press. In general, the one-touch away feature makes it easier for a user to place his HVAC system into an energy saving operating mode using a user interface, which may be a thermostat. In the illustrated embodiment, the one-touch away feature calls for a single, one-touch, away button 310 to be placed on a screen that is most often displayed on the user interface, which is the “home screen” in the illustrated embodiment. FIG. 2 illustrates a typical “home screen.” Thus, in one embodiment, the one-touch away button 310 would be located somewhere on the home screen. In one specific embodiment, the one-touch away button 310 is located toward one corner of the home screen, as it is shown in FIG. 3.

In the illustrated embodiment, the one-touch away button 310 is always on the home screen. One press of the one-touch away button 310 places the HVAC system into an energy-saving operating mode. Another press of the one-touch away button 310 cancels the energy-saving operating mode, causing the system to re-enter a normal operating mode. In one embodiment, the one-touch away button 310 can be accessed remotely (e.g., by an application running on a Smartphone, a tablet or a personal computer).

FIG. 4 is a flow diagram of one embodiment of a method of placing an HVAC system into an energy-saving operating mode from a normal operating mode with a single press of a one-touch away button and returning to the normal operating mode from the energy-saving mode with another single press of the one-touch away button. The method begins in a start step 410. In a step 420, the HVAC system is operated in a normal operating mode in which information is provided to a user with a display, input is accepted from the user with a touchpad and a most-often displayed screen including a one-touch away button is displayed on the display. In a step 430, the HVAC system is placed into an energy-saving operating mode based on a single press of the one-touch away button. In a step 440, the HVAC system is returned to the normal operating mode based on another press of the one-touch away button. The method ends in an end step 450.

Those skilled in the art to which this application relates will appreciate that other and further additions, deletions, substitutions and modifications may be made to the described embodiments.

1. A user interface for use with an HVAC system, comprising:
a display configured to provide information to a user;
and
a processor and memory coupled to said display and configured to drive said display, said display further configured to display a most-often displayed screen including a one-touch away button and place said HVAC system into an energy-saving operating mode based on a single press of said one-touch away button.

2. The user interface as recited in claim 1 wherein said display is further configured to cause said HVAC system to return to a normal mode based on a single press of said one-touch away button.

3. The user interface as recited in claim 1 wherein said most-often displayed screen is a home screen.

4. The user interface as recited in claim 1 wherein said one-touch away button is located toward one corner of said most-often displayed screen.

5. The user interface as recited in claim 1 wherein said one-touch away button can be accessed remotely by an application running on one of:
a Smartphone,
a tablet, and
a personal computer.

6. The user interface as recited in claim 1 further comprising an HVAC system interface.

7. The user interface as recited in claim 1 wherein said user interface is a thermostat.

8. A method of controlling an HVAC system, comprising:
providing information to a user with a display;
accepting input from said user and
displaying a most-often displayed screen including a one-touch away button on said display; and
placing said HVAC system into an energy-saving operating mode based on a single press of said one-touch away button.

9. The method as recited in claim 8 further comprising causing said HVAC system to return to a normal mode based on a single press of said one-touch away button.

10. The method as recited in claim 8 wherein said most-often displayed screen is a home screen.

11. The method as recited in claim 8 wherein said one-touch away button is located toward one corner of said most-often displayed screen.

12. The method as recited in claim 8 further comprising gaining access to said one-touch away button with an application running on one of:
a Smartphone,
a tablet, and
a personal computer.

13. The method as recited in claim 8 wherein said user interface is a thermostat.

14. An HVAC system, comprising:
a heat pump or a compressor having at least one stage;
at least one condenser coil;
an expansion valve;
at least one evaporator coil;
a loop of pipe interconnecting said heat pump or compressor, said at least one condenser coil, said expansion valve and said at least one evaporator coil and containing a refrigerant;
at least one fan configured to cause outdoor air and indoor air to blow over said at least one condenser coil and said least one evaporator coil; and
a user interface, including:
a display configured to provide information to a user,
a touchpad configured to accept input from said user, and
a processor and memory coupled to said display and said touchpad and configured to drive said display and process said input, said display further configured to display a most-often displayed screen including a one-touch away button and place said HVAC system into an energy-saving operating mode based on a single press of said one-touch away button.

15. The HVAC system as recited in claim 14 wherein said display is further configured to cause said HVAC system to return to a normal mode based on a single press of said one-touch away button.

16. The HVAC system as recited in claim 14 wherein said most-often displayed screen is a home screen.

17. The HVAC system as recited in claim 14 wherein said one-touch away button is located toward one corner of said most-often displayed screen.

18. The HVAC system as recited in claim 14 wherein said one-touch away button can be accessed remotely by an application running on one of:
a Smartphone,
a tablet, and
a personal computer.

19. The HVAC system as recited in claim 14 wherein said user interface further includes an HVAC system interface.

20. The HVAC system as recited in claim 14 wherein said user interface is a thermostat.
